(19) United States
(12) Patent Application Publication
(10) Pub. No.: US 2008/0052328 A1
(43) Pub. Date: Feb. 28, 2008

(54) ABSTRACTED AND OPTIMIZED ONLINE BACKUP AND DIGITAL ASSET MANAGEMENT SERVICE

(75) Inventors: Benjamin B. Widhelm, Sherman Oaks, CA (US); Michael C. Fisher, Venice, CA (US)

Correspondence Address: PAUL, HASTINGS, JANOFSKY & WALKER LLP, 875 15th Street, NW, Washington, DC, 20005, US

(73) Assignee: ElephantDrive, Inc., Los Angeles, CA (US)

(21) Appl. No.: 11/775,809

(22) Filed: Jul. 10, 2007

Related U.S. Application Data
(60) Provisional application No. 60/806,911, filed on Jul. 10, 2006.

(51) Int. Cl. G06F 17/30; H04L 9/32

(52) U.S. Cl. 707/204; 726/32; 707/E17.007

(57) ABSTRACT

A system and method for providing online storage and security. Digital assets are sent from client applications to server applications. The server implements an algorithm that optimizes the storage of digital assets. The server extracts the meta-data from digital assets and stores the meta-data in a relational database. The storage of digital assets will depend on analyzing the meta-data; factors such as file type, frequency of usage, and frequency of access are considered by the storage destination optimizing algorithm. The server also implements an algorithm that protects the digital assets from unauthorized network access. Upon detection of network intrusion by the security algorithm, the digital assets of the compromised users will be frozen, then either be destroyed or render unreadable by the unauthorized user. The security algorithm may then send an instance of the digitals assets to the compromised user to ensure that the digital assets remain accessible.

### BACKGROUND OF THE INVENTION

1. Field of Invention

The present invention relates to data storage and more particularly to an easy-to-use and cost-effective online storage technique for digital assets that secures the digital assets and may remotely destroy digital assets in stored repositories in the event the stored digital assets are compromised.

2. Description of Related Art

The proliferation of digital cameras, MP3 players, and digital video recorders, combined with the transition to a paperless economy and the digital home-office has caused the quantity and the value of digital assets (e.g., files, documents, images, music, video, data, etc.) to skyrocket. People now use their computers to store important business and financial documents, expensive media collections, and irreplaceable photos and videos—all of which are at risk to hacking or theft. In today's society, digital assets always need to be protected, but remain accessible from anywhere. Efforts have been made by others to solve this problem, but none have succeeded in devising a solution that meets all of the following criteria: 1) highly secure, 2) easy-to-use, and 3) cost effective over time.

Data security is becoming increasingly important in an environment in which sensitive or confidential data is frequently stored on laptops, personal digital assistants (PDAs), cell phones, or other easily transportable devices. This trend has exacerbated an existing problem—when hardware is lost or stolen, the data contained therein is often at risk of falling into the wrong hands and being abused. In the wrong hands, sensitive data such as medical records, financial information, identification data, and trade secrets are likely to be exploited, leading to instances of theft and fraud. Remote storage of sensitive data partially solves this problem, but does not present a solution that takes appropriate security measures to prevent data theft when original copies of the remotely stored sensitive data becomes compromised.

Conventional storage techniques can be divided into two categories—offline and online. Offline and hardware-based approaches include: external hard drives; in-system redundant array of inexpensive disks (RAID) configurations (i.e., configuring a desktop or laptop with multiple redundant disks); saving to floppy, compact disc, or digital disks; and in-home file and storage servers. Online and software-based approaches include: traditional online backup to a single managed storage system (i.e., online lockers); publicly available low-cost storage and application programming interfaces (APIs); and peer to peer storage systems.

Conventional security techniques can be divided into two categories—“blocking” solutions and “obfuscation” solutions. Blocking approaches create perimeters around individual digital assets or groups of digital assets. For example, applying password protection to a file creates a perimeter around the file through which, theoretically, only a password holder may pass. Similarly, at the operating system level, user logins and permission sets erect a blocking perimeter through which only users with knowledge of the password may pass. Other instances of blocking include BIOS level password protection or bio-metric identification protection at the firmware or hardware level.

The shortcomings of the “blocking” solutions are numerous. “Blocking” solutions are only as effective as the end-user's commitment to protect their passwords. Some users, for example, consistently choose to leave their operating system accounts open and their files unprotected by passwords. Other passwords are vulnerable to “dictionary” or “over-the shoulder” attacks. As long as yellow post-it notes are stuck to monitors with passwords written on them, or users maintain files on their systems with names like “Password.doc,” security will be compromised.

Obfuscation solutions differ from blocking solutions. Rather than creating a perimeter around the digital assets, obfuscation solutions alter the data of the assets. Typically, obfuscation solutions use encryption algorithms to re-constitute the data in such a way as to make them effectively gibberish for unauthorized users lacking the access to the encryption algorithm and the encryption key. These solutions suffer from the similar vulnerabilities, such as the dictionary attacks mentioned above, and rely heavily on keeping keys secured.

All of the offline data storage approaches have similar shortcomings for consumers. They require administration of additional hardware, and in some cases, administration that requires significant technical skill. Offline data storage approaches have fixed limits on their capacities—you can only store so much on any given disk, drive, or array, after which you must decide what to keep and what to delete, or add additional space. These approaches are all subject to loss, theft, and damage. And these approaches are all exposed to the “same-site” vulnerability—that is, certain events that can damage the primary copy of data can simultaneously damage the backup copy (e.g., in a fire or flood, both the computer and the backup media can be destroyed if they are housed in the same location).

The offline choices also have shortcomings for their providers. They have high production and distribution costs, and cannot be easily modified. Another problem with offline data storage approaches for consumers is data and file management. File management is not ubiquitous when there are a number of offline storage devices attached internally or externally to computing devices such as a computer terminal. Consumers are forced to spend time to manage, transfer and label files on each storage volume.

Although offline storage devices have progressively increased in capacity, so too have data file sizes. Files such as multimedia presentations, non-compressed audio and video, and high resolution video and photos can quickly fill up even the largest available sized offline storage devices in the market.

The existing online approaches address many of the shortcomings of the offline solutions, but have drawbacks of their own. The existing solutions have high switching costs, making it difficult for consumers to take advantage of technological advancements and lower pricing when it becomes available. If a storage repository that is more secure, more reliable, faster or more economical than existing options becomes available, a consumer will have to take the time and energy to re-create their backup copy and learn to navigate a new interface to enjoy the benefits of the enhanced offering. In the case of the Peer-to-Peer solutions, they require that the host machine that is holding data to be on and available at all times.

The existing online approaches do not address the need for mobile access to data from portable devices other than notebook PCs. The existing online approaches do not have easy-to-use interfaces that allow pocket-sized mobile devices to efficiently upload and download files. Devices such as PDAs and cell phone are becoming more suitable for data transactions due to interface improvements and expanded memories to store digital assets.

The online options have shortcomings for their operators as well. Operators are faced with three challenges—the development of online backup and storage software, the marketing of that service to consumers, and the maintenance of enterprise class storage solutions. This third challenge is an unnecessary burden to the operator, requiring time and energy on the part of the provider without providing any incremental value to the consumer, as well as a significant capital expenditure up front in order to accommodate large volumes of storage—a burden that can be mitigated, delayed, or avoided entirely by integration with an enterprise class Storage-as-a-Service provider.

The solution, therefore, is to provide secure, efficient, and affordable online digital asset storage. An online digital asset storage solution with strong security and efficiency will naturally be an affordable option. The two things that drive up operational costs are overhead costs from inefficiencies in data management and losses due to security breaches. Even the most secure networks are susceptible to security breaches. When such breaches occur, immediate intrusion detection and data protection is of the highest importance.

### SUMMARY OF THE INVENTION

The present invention overcomes these and other deficiencies of the prior art by enabling end users (individual consumers and corporate entities) to store their digital assets, automate backup procedures, and access their digital assets remotely over the Internet, by making use of the optimal mix of one or many storage repositories or repository services. The present invention is distinguished, at least in part, from other online backup and storage offerings because it serves as an intelligent aggregator of the available “wholesale alternatives”—the two good examples of which are providing direct access to a professionally managed hardware solution and providing frictionless intermediated access to a low-cost service provider of storage space. The decoupling of the management tools from the data itself allows storage to be offered to users at the lowest cost per unit of security and reliability over time, without imposing any switching costs on the user as the menu of options changes. The present invention enables individuals to remotely destroy their original digital assets in the event that their device becomes compromised as a result of loss or theft while preserving the copies stored by the service. For maximum security, the present invention can be used in tandem with other blocking and obfuscation techniques. The present invention alone can also be used to provide network data security to users without the need to deploy any further security techniques.

The present invention offers storage advantages to both the end users and operators over currently available offerings. For end users, the present invention eliminates the switching costs of moving to a service that takes advantage of better or cheaper technologies either not available or not economical at the time they selected a backup service. For operators, the present invention allows an online backup and storage business to be created with minimal initial capital outlay, by leveraging one or more storage services as opposed to investing in self-managed storage hardware at the outset. It also allows an online backup and storage business to narrowly focus its resources—existing businesses must invest resources into three key areas: developing management and control software, marketing their software or service to users, and managing enterprise storage. The present invention obviates the need for an online backup and storage business to worry about enterprise storage management, thus reducing the expense structure and optimizing resources against software development and product marketing.

The present invention offers advantages over currently available offerings in data security. The end user's digital assets are now redundantly stored; the digital assets are in a location separate from their primary host, eliminating “same-site” vulnerabilities. The present invention requires little additional cooperation or discipline from end users to be effective after its initial setup. The algorithms in the present invention are modular and scalable, capable of adapting to the different enterprise database platforms. The invention is scalable in that it is capable of handing a spectrum of end-users without any impact on system performance: from consumer home storage to corporation storage. The modularity of the system allows for the seamless addition of both new software and hardware to the system as the numbers of users increase.

The present invention provides an additional layer of proactive protection, and, in the event it is successfully deployed, confirmation of the implemented counter-measure. Unlike other security systems, this invention takes a proactive role in eliminating or minimizing the risks associated with compromised devices. This confirmation is extremely valuable; it gives an end user piece of mind that the sensitive data that may have been exposed has been destroyed or encrypted—end users may confidently declare that the exposure risk has been minimized or eliminated. Furthermore, because the invention is tied to a system remote from a user's primary host, end users enjoy the benefit of being able to destroy the compromised instance of the data while retaining a usable and easily accessible copy.

The present invention offers advantages to both end users and operators over current offerings by utilizing a management algorithm that efficiently allocates system resources to maximize them. This is beneficial to the operators because it saves on overhead costs, such as the need to purchase more hardware. Although this backend process is invisible to end users, the cost savings for the operators allows the operators to offer a cheaper alternative to the cycle of purchasing new hardware and incurring switching costs.

The present invention offers advantages to both end users and operators by utilizing a management algorithm that decreases the data access time by separating the metadata from the encrypted data and storing the metadata in a separate file system. The metadata relational file system serves as an index that speeds up file access time because it eliminates the necessity of searching through large files through each separate database each time there is a request to access a file. This makes the end user experience of accessing data faster and decreases operator overhead in using system resources to locate files and other digital assets.

The present invention offers advantages in terms of data security both physically and over the network. Portable data storage devices such as USB flash drives or other portable hard drives are susceptible to theft, damage or loss during transit. The present invention eliminates this possibility since the physical storage of a user's data is located in one or more secured locations. The present invention also provides far greater data network security. Although most consumers may have antivirus or firewall software running on their systems to protect their data from unauthorized access, such consumers may not be unaware of any system vulnerabilities. Indeed, consumers may not even be aware of any malicious software running on their computer systems that is already compromising their data security. The present invention utilizes diagnostic algorithms to detect suspicious network activity and prevent unauthorized access to data.

The present invention offers advantages in expanding the types of devices that are allowed to remotely access data. Personal portable digital devices such as PDAs and cell phones would be able to remotely download data previously uploaded, or upload data that is currently stored on the portable device.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the following descriptions taken in connection with the accompanying drawing in which:

FIG. 1 illustrates an online backup and digital asset management system according to an embodiment of the invention.

FIG. 2 illustrates a security application providing data security in an online backup and digital asset management system according to an alternate embodiment of the invention.

### DETAILED DESCRIPTION OF EMBODIMENTS

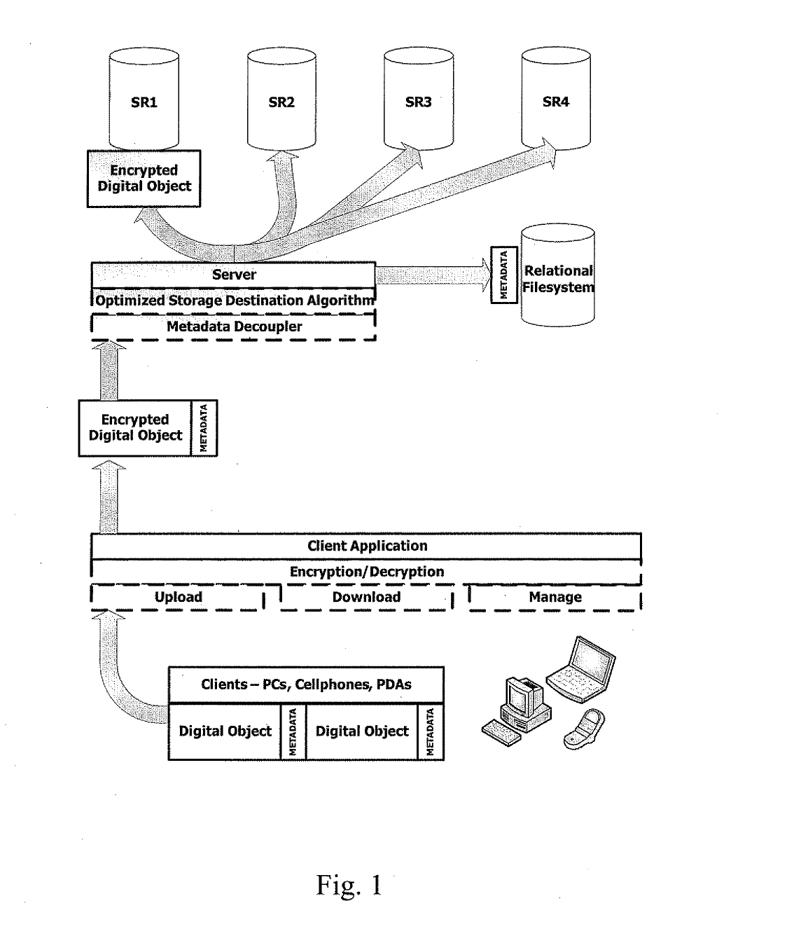

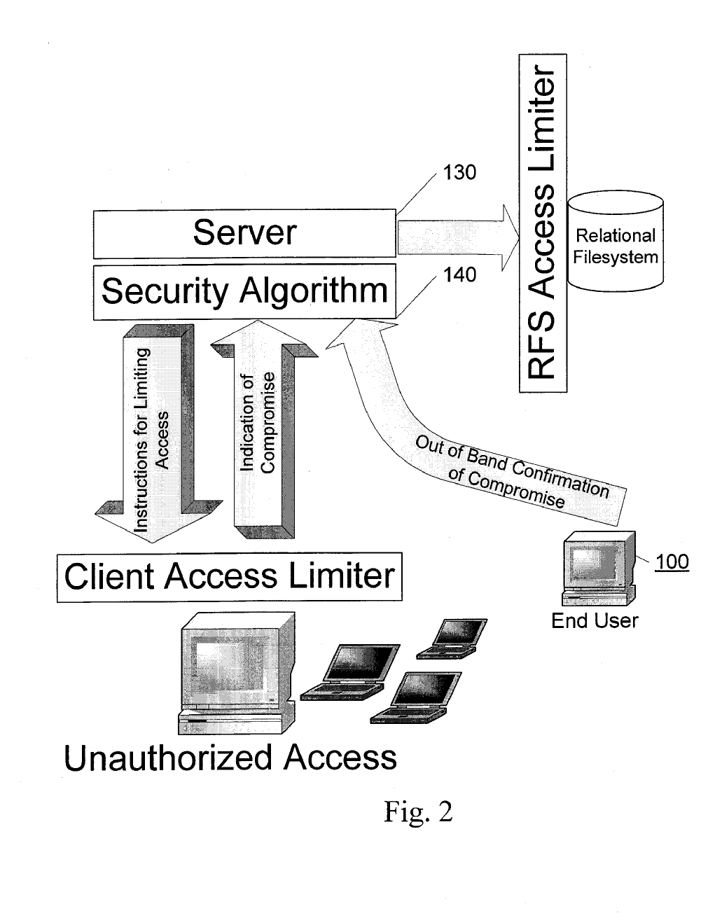

Embodiments of the present invention and their advantages may be understood by referring to FIGS. 1 and 2, and are described in the context of an online digital asset backup and storage technique. The present invention utilizes, among other things, low-cost or free disk space provided by, for example, major online enterprises looking to monetize their existing investments in storage infrastructure, currently embodied in Storage-as-a-Service offerings such as Amazon Web Services' Simple Storage Service (S3), Omnidrive, Streamload, Box.net, ElephantDrive, and others. When this happens, individuals may want or need software products that enable them to quickly and easily take advantage of these services, and to switch between them with minimal economic and psychological transaction costs, especially as competition between the storage providers depresses pricing and improves guarantees of reliability.

The present invention addresses the shortcoming of the offline/hardware-based solutions. First, the need for additional hardware administration is eliminated by providing software-based access to storage repositories. Second, the problem of fixed-size is eliminated from the user's perspective as the storage is limitless and it requires no effort to exceed a committed allotment. Third, since industry standard best practices are employed for physical security, redundancy, and hardware administration and maintenance, the risk of loss, theft, and damage is infinitesimal. The identification and implementation of such industry standards are readily apparent to one of ordinary skill in the art. And lastly, the user's data is stored in a separate location from their primary host, eliminating the “same-site” vulnerability. From an operator/provider point of view, the present invention cheaply distributes new and improved versions of client software required to access the platform, including executables installed on desktops and applications hosted at web sites and executed within a browser over the Internet, and has only nominal production and distribution costs.

The present invention also addresses the problems presented by conventional online/software-based solutions. By decoupling the metadata from the binary objects, a fully abstracted storage solution is enabled. A user's digital assets may be stored in any storage repository or storage service, and the present invention dynamically shift objects from one repository or service to another. This can be done while the user accesses and manages his or her objects, using the same interface regardless of where the object is housed. This solves the problem of high switching costs associated with migrating from one solution to another, as migration can be affected behind the scenes. Users can enjoy the technological enhancements and cost savings without expending time and energy or learning a new interface.

From the operator/provider point of view, the present invention eliminates the need for enterprise storage management expertise and dramatically reduces the start-up and/or ongoing capital expense associated with offering an online backup and storage service, although the present invention can be adapted to be used with enterprise management solutions.

FIG. 1 illustrates an online backup and digital asset management system 100 according to an embodiment of the invention. The online backup and digital asset management system 100 comprises: a relational file system 110, a client program 120, and a server application 130. The relational file system 110, the client program 120, and the server application 130 may be implemented as software and/or hardware.

The relational file system 110 decouples metadata from object data, i.e., digital assets (referred to as “digital objects” in the figure). This file system is unique, providing multiple improvements over existing file systems such as FAT or NTFS, as it uses a database and advanced data structures to manage and index metadata, along with its relationship to actual storage. Metadata is data about data. Customarily, metadata comprises “implicit” information about a file such as the title, subject, author, file format, and the size of the file. Additionally, the file system 110 expands on traditional set of datum by allowing the integration of “explicit” metadata, such as tagging. However, metadata is highly customizable and can be expanded to include other characteristics regarding a data file—that metadata could include executable software code or scripts.

An algorithm in the server application 130 evaluates a number of metrics, such as response latency, capacity, availability, failure rates, and cost to govern the initial storage and movement of objects. These metrics give feedback as to the efficacy of performance of the digital asset management system 100. Accordingly, the algorithm in server application 130 manages the distribution of data in digital asset management system 100 by evaluating several factors for efficient file access. These factors are weighted by the system operators and can be dynamically implemented into the digital asset management system. For example, home consumer multimedia files that would be accessed more often than corporate backup data would be stored in or relocated to physical storage that are faster to access, similar to a cache in a computer system. Some of the factors considered by the management algorithm would include file size, file format, and prior frequency of access. The management algorithm would be expandable to consider other metrics to better suit end user access habits.

The relational file system 110 stores the relationships that can exist between objects and users, and the relationships that can exist between objects themselves. By making use of Single Instance Storage (SIS), the global file system may take multiple users' directories that have different but similar binary objects, match them based on a hashing algorithm, the implementation of which is apparent to one of ordinary skill in the art, and merge similarities into a single binary object (or instance) and create references to that binary object. Hash matching is performed in real-time (when an object is presented by the user for addition to the global file system, it is first checked against a global hash map to determine what portions of the binary object are needed, if any) and asynchronously, consolidating more granular portions of binary objects after longer arguments have been introduced. Additionally, the relational file system 110 identifies the attributes that the binary objects may have, including physical location or locations of each of the binary object itself.

The relational file system 110 divides metadata about a particular object into three distinct categories: Implicit, Explicit, and Operational. Implicit metadata includes all attributes inherent to the binary object, including its type, size, name, creation dates, modification dates, and access dates, anything included by the metadata contained with the original binary object as it existed on the users file system, and read by client software. Implicit metadata in the relational file system is also inclusive of inherent qualities derived from the file, such as access histories (download, update, etc) and type category (audio, video, image, document). This latter piece of metadata assists in creating more intuitive user interfaces to data by breaking down the traditional hierarchical layout of file systems. Explicit metadata is information supplied by users or a group of users that describe the binary objects with keywords that are later indexed for simple retrieval, sometimes known as “tagging.” Finally, Operational metadata is specific to the relational file system, and never exposed to a user. This is inclusive of address information (where the actual binary arguments are stored), encryption information, compression information, and its relationship to other objects in the system (i.e. the binary object is dependent on another for some or all of its actual binary data). These locations are storage repositories or frames, representative of one or more virtual volumes (e.g., SR1, SR2, SR3, and/or SR4).

The present invention implements an optimized storage algorithm, designed to match binary objects with their Implicit and Operational metadata for efficiency in storage, retrieval, and security. Volumes in the system are given a score based on a weighted average of their associated cost (measured in price per gigabyte per month stored), availability (measured in mean time between observed failure), read/write/network throughput speeds (measured in observed kilobytes per second), capacity (measured in available gigabytes), and security (measured in a score based on availability of secure transfer protocols, physical location of disks, and mean time between compromise). Volumes with poor scores across availability and security will be dropped from the system and have its data/objects/digital assets transferred elsewhere; volumes with insufficient capacity become unavailable for additional storage while still maintaining availability for retrieval. Finally, the algorithm combines this score with Implicit metadata of the binary object to determine the most advantageous destination or group of destinations for its contents.

For example, a binary object that has associated metadata that specifies the object as a type category of infrequently modified and accessed word processing documents is matched with a storage repository with high scores for reliability and security, such as commoditized disk arrays residing in an internally controlled secure datacenter. Alternatively, a binary object with associated metadata describing the object as a type category of unmodified, but frequently accessed audio will be matched with a volume with high scores for capacity and throughput performance, such as Storage-as-a-Service offerings and peer to peer networks. Access and modification histories may dictate that an object be graduated to another storage repository, or replicated. During this process the hash signature of the binary contents of the object are verified on each end of a transfer, ensuring data integrity.

After objects have been adequately verified and stored on an appropriate volume or volumes, a record is reflected in the operational metadata as complete. Object and content retrieval requires authorization by both the application and the user, checking against a cascading set of permissions. This allows the system to provide streamlined access to secure storage and assets within.

A storage repository or frame can comprise any type of network addressable storage, such as the internally managed Network Attached Storage (NAS), Fibre-Channel SCSI, or iSCSI storage architectures, or some other external storage service. Virtual volumes include one layer of classification beyond a storage repository (storage repositories may have multiple volumes) and, once added as available targets in the system, are measured granularly on the basis of their cost, performance (speed), reliability (mean time between failure), and security. Volumes are virtualized in that they are controlled by the global relational file system, and can be added, expanded, or otherwise modified at any time. Using these relationships and attributes as a guide, the relation file system 110 implements a normalized schema, in which entity types are organized to increase cohesion to eliminate data redundancy and store information about objects and users that will retain its relational integrity and allow a complete representation of the individual user's virtual file system to be viewed, modified, added to or deleted from. The procedures for viewing, modifying, adding to, and deleting from are designed to ensure the integrity of the system, protecting against false positives. The relational file system 110 is in communication with the server application 130. The relational file system 110 receives object data and/or metadata as well as commands from the server application 130, carries out the commands, and transmits object data and/or metadata back to the server application 130 as requested. Communication between end users and the relational file system is performed through the server application exclusively.

The client program 120 interfaces end users to the system 100. The client program 120 may be implemented as a software program capable of interacting with network-enabled programs such as browsers and messaging applications over a remote network 125, though it can also be implemented by embedded integrated circuits or other forms of hardware. The client program 120 is able to request and receive data, and present a graphical representation of the data to a user. The client program 120 can reside either on the server machines, on the client machines, or both. The client program 120 enables the user to view, modify, add, and delete objects and metadata from the relational file system 110, as well as access the binary objects themselves upon request. In an embodiment of the invention, the client program 120 encrypts a binary object into an encrypted digital object 128 prior to sending them to the server application 130, and decrypts the digital object upon receiving them from the repository in which it is stored. Encryption can be implemented using any standard encryption scheme, the identification and implementation of which are apparent to one of ordinary skill in the art.

In an embodiment of the invention, the server application 130 provides a web-based service that binds the metadata and objects provided by the client program 120 with the relational file system 110 and oversees the deposit of the objects into a storage repository (e.g., SR1, SR2, SR3, and/or SR4) or service. The server application 130 may be implemented as a software program capable of interacting with other network-enabled programs over the remote network 125. The server application 130 retrieves information from the relational file system 110 and delivers it to the client application 120. The methodology for object retrieval is dictated by Operational metadata, specifying where the object is located amongst the group of virtual volumes, its encryption method and associated key, its compression method, and its dependence on other objects in the system. In the event that the object is encrypted or compressed, additional client software may be necessary. The server application 130 receives formatted messages from the client application 110 to perform actions to add, modify, or delete binary objects and metadata on the relational file system 110, execute on these actions, and return confirmations or error messages to the client application 120. Client messages are formatted in the form of Simple Object Access Protocol (SOAP) envelopes or Representational State Transfer (REST) messages to a secure HTTP server. Binary objects (file data) can be transferred similarly, or streamed via common internet protocols, such as TCP or UDP. The server application 130 manages acceptance and transfer of binary objects to be added to the relational file system 110, in whole or in part either directly to the storage repository or to the server application as an intermediary, and communicates the results to the client application 120. The server application 130 delivers access information in the form of a session key identifier to the client application 120, so that it can locate, request, and receive one or more binary object when a user instructs it to. Additionally, the server application 130 deposits the binary objects in one or more of the storage repositories (e.g., SR1, SR2, SR3, and SR4), and moves the binary objects from one repository to another while updating the relational file system 110 accordingly.

In a related embodiment of the invention, the online backup and digital asset management system 100 implements a security scheme that allows for the storage of the binary objects by third parties. The security scheme comprises a mechanism for encrypting binary objects so that they can be stored by third parties, but never accessed by third parties. In a preferred embodiment of the invention, the security scheme calculates and stores two file signatures or secure one-way hash values prior to encryption. One signature can be stored in the relational file system 110 in plain text and used to verify the integrity of the object after download and decryption. The other signature can be used as the key with which to encrypt the object. This signature-key can then be encrypted with a separate pass-phrase contained in a certificate either supplied by the user or randomly generated by the server application and stored in the relational file system 110. Such a system optimizes the balance between security and flexibility, offering “defense-in-depth” (an attacker would have to compromise several layers of security, encryption, and abstraction in order to compromise the system) while allowing for flexibility and sharing (digital assets can be shared by key-sharing, minimizing computation and binary manipulation).

In an embodiment of the invention, the relational file system 110 physical servers on which the server/service applications are implemented are deployed in a secure data center facility with high-availability and high-throughput connectivity to the Internet. One or more storage repositories are identified and attached to the server 130, either within the data center facility or in another such facility. The repository or facility may be managed and/or hosted by a third party. In a related embodiment of the invention, several storage repositories are employed, some internal (such as an internally managed storage array), and some external to the data center facility.

An alternate embodiment of the present invention may be understood by referring to FIG. 2 and is described in the context of ensuring the security of compromised client systems. The present invention increases the security of digital assets by obscuring or deleting all original copies of digital assets associated with an end user whose original storage medium has been compromised and suspending access to the online, secured digital assets from the compromised medium. This adds significant value to online storage services. Regardless of whether an end user is a home consumer or a corporate enterprise, one must spend time and money to ensure their digital assets are safe from physical theft or malicious network attacks, but this system provides an additional failsafe mechanism in event that theft or attack is successful. The present invention provides an economical alternative to the overhead costs associated with user-provided network security.

FIG. 2 illustrates the relationship between the server 130, the security mechanism 140 and its relationship with the global file system 100. Upon detection of an unauthorized access to the global file system 100, the security mechanism 140 will take precedence over all other operations on server 130. Upon a network security breach, security mechanism 140 refers to relational file system 110 to identify all end users whose digital assets are affected by the unauthorized access and to freeze access to all digital assets related to the user from the compromised medium. Then, the security mechanism 140 will immediately either destroy or render unreadable all digital assets associated with the end users on the compromised medium, or destroy or render unreadable only the digital assets sought after by unauthorized access on the compromised medium. Prior to the destruction of any files as a result of a security breach of relational file system 110 and server 130, a copy of the files may be sent to the end user to ensure that files are immediately accessible.

In a related embodiment of the invention, the relational file system 110 and server 130 implements a security mechanism 140 where objects in both storage repositories and relational database 110 are immediately encrypted. This option is chosen by the end user and can be changed anytime. The server 130, upon detecting a network activity indicating a network attack by an unauthorized user, such as a Denial-of-Service attack, will activate the security mechanism. All files that the unauthorized user is trying to access will be immediately encrypted such that the files effectively become gibberish for the unauthorized user.

In a related embodiment of the invention, the security mechanism 140 of the relational file system 110 and server 130 detects unauthorized system access by scanning systems logs for anomalies in network traffic, attempts at buffer overflow, any alterations in key system files or the database root directory, or suspicious activity in an end user account, such as a frequent change of passwords.

When the security mechanism 140 deletes files and data to prevent unauthorized access, it first looks to relational database 110 to identify the metadata of the files being accessed to obtain the end users being affected by the unauthorized access. The security mechanism will then gather a set of all binary objects to be deleted from the physical repositories (SR1, SR2, SR3, and/or SR4). The metadata regarding the end user and the locations of the digital assets on the physical repositories are not immediately deleted. Prior to the execution of the deletion command, the security mechanism 140 will ensure that an instance of the object is not lost by electronically sending a copy of all files to be deleted to the end user.

Combined with out-of-band authorization from the effected user, the hash signature is matched to binary objects on the target client file system for remote destruction. For example, a system user who has had their PC lost or stolen can notify the operators of the system that they wish their data to be destroyed. A sentinel is set to listen for the MAC address of the network card(s) associated with the users account, and send hash signatures to the client service on the PC to destroy the successfully backed up content. The destruction may performed by overwriting the existing byte arguments with randomly generated binary arguments or, in the event of a full volume backup, removing the disk's partition.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

We claim:

1. An online backup and object management system comprising:
a relational file system, wherein said relational file system stores information pertaining to a relationship that can exist between an object and an end-user, and
a server application that binds said object with said relational file system.

2. The system of claim 1, wherein said relational file system abstracts metadata from object data of said object.

3. The system of claim 2, wherein said object comprises a digital asset.

4. The system of claim 1, wherein said relational file system further stores information pertaining to a relationship that can exist between said object and another object.

5. The system of claim 1, wherein said relational file system identifies one or more attributes of said object.

6. The system of claim 5, wherein said one or more attributes include a physical location of said object.

7. The system of claim 1, further comprising a client program, wherein said client program interfaces users with said online backup and object management system.

8. The system of claim 2, wherein said server application binds said metadata with said relational file system and oversees the deposit of said object into a storage repository.

9. The system of claim 1, wherein said server application comprises a web server application.

10. The system of claim 7, wherein said server application retrieves information from said relational file system delivers it to said client program.

11. The system of claim 7, wherein said server application receives requests from said client program to perform actions on said relational file system, execute said actions, and return confirmations or error messages to said client program.

12. The system of claim 7, wherein said server application delivers access information to said client program so that it can locate, request, and receive said object.

13. The system of claim 1, wherein said system further comprises an algorithm to optimize storage destination.

14. The system of claim 13, wherein said algorithm is implemented on said server application.

15. The system of claim 1, wherein said server application deposits said object into one or more storage repositories.

16. The system of claim 15, wherein said object is encrypted by said security mechanism prior to deposit of said object in one or more storage repositories.

17. The system of claim 15, wherein said server application moves said object from one storage repository to another and updates said relational file system accordingly.

18. The system of claim 1, wherein said online backup and object management further comprises a security mechanism that detects unauthorized access and activates security measures upon unauthorized access.

19. The system of claim 18, wherein one of said security measures is to delete all digital assets pertaining to the end user upon an unauthorized access to any of the digital assets pertaining to the end user.

20. The system of claim 18, wherein one of said security measures is to delete any digital assets the unauthorized access attempts to access.

21. The system of claim 18, wherein one of said security measures is to encrypt all binary objects pertaining to the end user upon an unauthorized access to any of the digital assets pertaining to the end user.

22. The system of claim 19 or 20, wherein the server application sends a copy of deleted digital assets to the end user.

23. A method to managing digital assets and backing up data online comprising the steps of
receiving of binary objects and metadata to a server application,
decoupling information pertaining to a relationship that can exist between an object and an end-user, and
storing said information in a relational database.

24. The method of claim 23, wherein said server application retrieves information from said relational file system delivers it to said client program.

25. The method of claim 23, wherein said server application receives requests from said client program to perform actions on said relational file system, execute said actions, and return confirmations or error messages to said client program.

26. The method of claim 23, wherein said server application delivers access information to said client program so that it can locate, request, and receive said object.

27. The method of claim 23, wherein said relational file system extracts metadata from object data of said object.

28. The method of claim 23, wherein said objects comprises a digital asset.

29. The method of claim 23, wherein the client application can be accessed remotely by the end user.

30. The method of claim 23, wherein said relational file system identifies one or more attributes of said object.

31. The method of claim 23, wherein said server application binds said metadata with said relational file system and oversees the deposit of said object into a storage repository.

32. The method of claim 23, wherein said server application moves said object from one storage repository to another and updates said relational file system accordingly.

33. The method of claim 23, wherein said server application implements an algorithm to optimize storage destination.

34. A method to prevent unauthorized access to objects in an online backup and object management system comprising the steps of
applying an algorithm in a security mechanism to detect unauthorized access to the said system, and
identifying the end users whose data objects are compromised by unauthorized access to said system.

35. The method in claim 34, wherein objects comprises of digital assets.

36. The method in claim 34, wherein all access to the object pertaining to an identified end user upon unauthorized access to said system are prohibited.

37. The method in claim 34, wherein all objects pertaining to identified end users in said system are deleted upon unauthorized access to said system.

38. The method in claim 34, wherein a copy of all objects deleted is sent electronically to the end user.
